(19) United States
(12) Patent Application Publication
(10) Pub. No.: US 2022/0011117 A1
(43) Pub. Date: Jan. 13, 2022

(54) POSITIONING TECHNOLOGY

(71) Applicant: Beijing Sankuai Online Technology Co., Ltd., Beijing (CN)

(72) Inventor: Baoshan CHENG, Beijing (CN)

(21) Appl. No.: 17/289,239

(22) PCT Filed: Aug. 27, 2019
(86) PCT No.: PCT/CN2019/102755

§ 371 Date: Apr. 28, 2021

(30) Foreign Application Priority Data
Aug. 28, 2018 (CN) 201810987799.6

(51) Int. Cl. G01C 21/30; G06K 9/00; G06K 9/62; G06T 7/73

(52) U.S. Cl. CPC G01C 21/30; G06K 9/00791; G06T 2207/30252; G06T 7/73; G06K 9/6202

(57) ABSTRACT

This application provides a positioning solution, wherein the solution includes: determining first feature information and semantic category information of a first road-related element in an image, wherein the image is taken by a mobile device in a moving process; determining second feature information of a second road-related element whose semantic category information is identical to the semantic category information in a high-definition map; and positioning the mobile device based on a matching result of the first feature information and the second feature information.

### CROSS REFERENCE TO RELATED APPLICATIONS

This application is a national phase entry under 35 USC 371 of International Patent Application No. PCT/CN2019/102755, filed on Aug. 27, 2019, which claims priority to Chinese Patent Application No. 201810987799.6, titled “POSITIONING METHOD, DEVICE, STORAGE MEDIUM ΔND MOBILE DEVICE”, filed on Aug. 28, 2018, the contents of all of which are incorporated herein by reference.

### TECHNICAL FIELD

This application relates to the field of positioning technologies.

### BACKGROUND

A high-definition map usually includes a vector semantic information layer and a feature layer, wherein the feature layer may include a laser feature layer or an image feature layer. In a positioning method by using the high-definition map, the vector semantic information layer and the feature layer may be positioned respectively, and then a final positioning result is obtained by integrating positioning results obtained by the two. A positioning method based on the feature layer needs to extract image or laser feature points in real time, and then calculate position and posture information of an unmanned vehicle through feature point matching combined with computer vision multi-view geometry principle. However, a storage volume of the feature layer is large, and it is easy to increase a probability of mismatching in an open road environment, which leads to the decline of positioning accuracy. However, a positioning method based on the vector semantic information layer needs to accurately obtain contour points of related objects (for example, road identifiers, traffic identifiers, etc.). If the contour points are extracted inaccurately or the number of contour points is less, large positioning errors will easily occur.

### SUMMARY

In light of this, this application provides a positioning method and device, a storage medium and a mobile device, which can reduce extraction accuracy requirement of contour points on road-related elements and avoid the increase of a positioning failure probability due to inaccurate extraction of contour points or less number of contour points.

To achieve the foregoing objective, this application provides the following technical solutions.

According to a first aspect, this application provides a positioning method, including:

determining first feature information and semantic category information of a first road-related element in an image, wherein the image is taken by a mobile device in a moving process;

determining second feature information of a second road-related element whose semantic category information is identical to the semantic category information in a high-definition map; and

positioning the mobile device based on a matching result of the first feature information and the second feature information.

According to a second aspect, this application provides a positioning device, including:

a first determination module, configured to determine first feature information and semantic category information of a first road-related element in an image, wherein the image is taken by a mobile device in a moving process;

a second determination module, configured to determine second feature information of a second road-related element whose semantic category information is identical to the semantic category information in a high-definition map; and

a positioning module, configured to position the mobile device based on a matching result of the first feature information and the second feature information.

According to a third aspect, this application provides a storage medium, wherein the storage medium stores a computer program, and the computer program is configured to execute the positioning method according to the first aspect mentioned above.

According to a fourth aspect, this application provides a mobile device, the mobile device including:

a processor; and a memory for storing instructions executable by the processor;

wherein the processor is configured to execute the positioning method according to the first aspect mentioned above.

It can be seen from the above technical solutions that a physical meaning represented by the first road-related element is known by determining the semantic category information of the first road-related element in the image, so the semantic category information of the first road-related element may be regarded as a high-level semantic feature, and the first feature information of the first road-related element and the second feature information of the second road-related element in the high-definition map represent pixel information of the road-related elements, so the first feature information and the second feature information may be regarded as low-level semantic features. By combining the high-level semantic feature with the low-level semantic features, high-accuracy positioning of the mobile device is realized. As the image feature information of the road-related element in the high-definition map is abundant and the image feature information is accurate, and as the whole feature of the road-related element, the image feature information does not need to identify contour points of the first road-related element in the image, so the extraction accuracy requirement of contour points on the road-related elements is reduced and the increase of false positioning failure probability or positioning failure due to inaccurate extraction of contour points or less number of contour points is avoided.

### BRIEF DESCRIPTION OF THE DRAWINGS

FIG. 1A is a flow chart of a positioning method according to an exemplary embodiment of this application.

FIG. 1B is a schematic diagram of a traffic scene of the embodiment shown in FIG. 1A.

FIG. 2 is a flow chart of a positioning method according to another exemplary embodiment of this application.

FIG. 3 is a flow chart of a positioning method according to one another exemplary embodiment of this application.

FIG. 4 is a schematic structural diagram of a positioning device according to an exemplary embodiment of this application.

FIG. 5 is a schematic structural diagram of a positioning device according to another exemplary embodiment of this application.

FIG. 6 is a schematic structural diagram of a mobile device according to an exemplary embodiment of this application.

### DETAILED DESCRIPTION OF THE EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations set forth in the following description of exemplary embodiments do not represent all implementations consistent with this application. On the contrary, the implementations are merely examples of devices and methods that are described in detail in the appended claims and that are consistent with some aspects of this application.

The terms used in this application are for the purpose of describing specific embodiments only and are not intended to limit this application. The singular forms of “a” and “the” used in this application and the appended claims are intended to include the plural forms as well, unless the context clearly indicates otherwise. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Depending on the context, for example, the word “if” used herein may be interpreted as “while” or “when,” or “in response to determination.”

Various embodiments may be applied to a mobile device, which may be a vehicle, a robot for distributing goods, a mobile phone and other devices that may be used on outdoor roads. Taking the mobile device being a vehicle as an example, during a driving process of the vehicle, an image is taken by a camera on the vehicle, and a first road-related element in the image is identified, and image feature information of the first road-related element (first feature information in this application) is extracted; moreover, a second road-related element identical to the first road-related element in the image is found in a high-definition map, so that an image feature information of a second road-related element (second feature information in this application) in the high-definition map is compared with the image feature information of the first road-related element in the image, and the vehicle is positioned based on a matching result and a motion model of the vehicle.

The high-definition map in accordance with the present disclosure is provided by a map provider, and may be pre-stored in a memory of the vehicle or acquired from the cloud when the vehicle is running. As mentioned above, the high-definition map may include a vector semantic information layer and an image feature layer. The vector semantic information layer may be made by extracting vector semantic information of road-related elements such as road edges, lanes, road structure attributes, traffic lights, traffic identifiers, light poles, and the like in an image taken by the map provider, wherein the map provider may take the image by pick-up devices such as unmanned aerial vehicles. The image feature layer may be made by extracting the image feature information of the road-related element from the image. The vector semantic information layer and the image feature layer are stored in the high-definition map in a set data format. An accuracy of the high-definition map can reach a centimeter level.

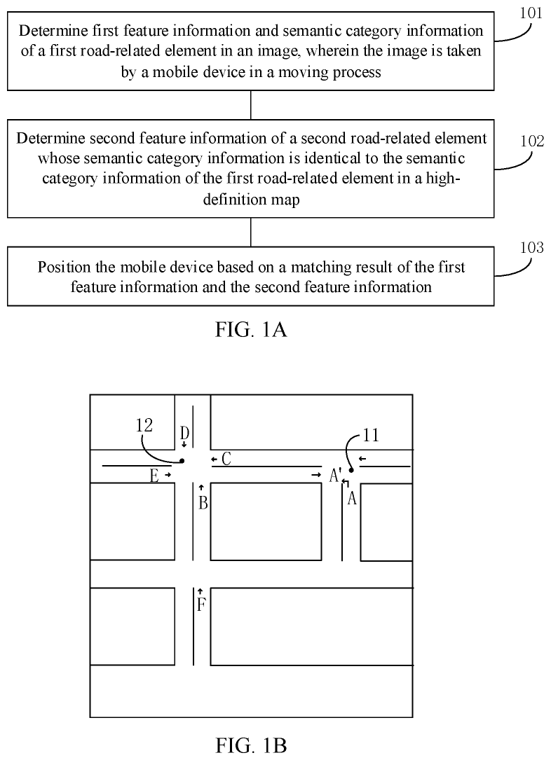

FIG. 1A is a flow chart of a positioning method according to an exemplary embodiment. FIG. 1B is a schematic diagram of a traffic scene of the embodiment shown in FIG. 1A. This embodiment may be applied to mobile devices to be positioned, such as vehicles that need to be positioned, robots that distribute goods, mobile phones, etc. As shown in FIG. 1A, the following steps are included.

In step 101, first feature information and semantic category information of a first road-related element in an image are determined, wherein the image is taken by a mobile device in a moving process.

In an embodiment, a position box where the first road-related element is located in the image may be determined through a deep learning network. The first feature information of the first road-related element is extracted from the position box where the first road-related element is located. The image may include a plurality of first road-related elements, and the plurality of first road-related elements may be: a traffic light, a road surface identifier (for example, a left-turn arrow, a straight-ahead arrow, a right-turn arrow, a number, a sidewalk, a lane line, an indicating character, etc.), and the like. By identifying the position box where the first road-related element is located in the image, interference of feature information of trees and pedestrians on the feature information of the road-related elements can be eliminated, so as to ensure the accuracy of subsequent positioning.

In an embodiment, the first feature information may be image feature information of the first road-related element, such as a corner point, a feature descriptor, a texture, a gray scale, and the like of the first road-related element. In an embodiment, the semantic category information of the first road-related element may be a name or a type identifier or ID) of the first road-related element, for example, the first road-related element is a traffic light, a road surface identifier (e.g., a left-turn arrow, a straight-ahead arrow, a right-turn arrow, a sidewalk, etc.), and the like.

In step 102, second feature information of a second road-related element whose semantic category information is identical to the semantic category information of the first road-related element in a high-definition map is determined.

In an embodiment, the high-definition map includes a vector semantic information layer and an image feature layer. The vector semantic information layer stores semantic category information of the road-related elements and model information of the road-related elements. The model information of the road-related elements may be length, width, height as well as longitude and latitude coordinates and elevation information of centroids of the road-related elements in a WGS84 (World Geodetic System-1984) coordinate system. The vector semantic information layer stores image feature information corresponding to the semantic category information of the road-related elements. The feature information of the road-related elements in the high-definition map is stored in the image feature layer of the high-definition map. The semantic category information in the vector semantic information layer is associated with the corresponding image feature information in the image feature layer, and coordinate positions of the centroids of the road-related elements stored in the vector semantic information layer are associated with coordinate positions where the image feature information of the road-related elements stored in the image feature layer are located. In other words, in one high-definition map, the coordinate positions of the image feature information of the road-related elements in the image feature layer may be determined based on the coordinate positions of the centroids of the road-related elements, and then the image feature information of the road-related elements are determined. In the embodiment of this application, by storing the feature information of the road-related elements in the image feature layer of the high-definition map, rich low-level feature information can be increased while ensuring that the high-definition map includes contains high-level semantic information.

In an embodiment, the high-definition map stores the image feature information and the semantic category information of the road-related elements. When it is necessary to determine the second feature information of the second feature information whose semantic category information is identical to the semantic category information of the first road-related element in the high-definition map, a first geographical position of the mobile device when taking the image may be determined first based on an existing positioning system of the mobile device (for example, GPS (Global Positioning System) positioning system, Beidou positioning system, etc.). The first geographical position may be expressed by longitude and latitude or UTM (UNIVERSAL TRΔNSVERSE MERCARTOR GRID SYSTEM) coordinates. The second road-related element whose semantic category information is identical to the semantic category information is determined within a set range from the first geographical position in a vector semantic information layer of the high-definition map; and the second feature information of the second road-related element is determined in the high-definition map. Because only the second road-related element whose semantic category information is identical to the same semantic category information of the first road-related element needs to be determined in the high-definition map, searching of non-road-related elements in the high-definition map is avoided, and time for searching the second road-related element in the high-definition map is greatly shortened.

Further, the preset range may be determined by an error range of the positioning system, so that an error generated by the positioning system can be corrected. The application does not limit a specific value of the preset range. For example, if the preset range is 5 meters, and the semantic category information includes traffic lights and a left-turn arrow, then the traffic lights and the left-turn arrow within 5 meters may be searched in the high-definition map with the first geographical position of the mobile device when taking the image as the center, to find respective second feature information of the traffic lights and the left-turn arrow within 5 meters from the high-definition map. Similar to the first feature information, the second feature information is, for example, a corner point, a descriptor, a structure, a texture, a gray scale, and the like of the second road-related element.

In step 103, the mobile device is positioned based on a matching result of the first feature information and the second feature information.

In an embodiment, the first feature information may be compared with the corner point, the descriptor, the texture, the gray scale, and the like included in the second feature information. If the first feature information and the second feature information are determined to be the same or similar through comparison, the matching result meets a preset condition, and the mobile device can be located based on geographical coordinates of the second road-related element in the high-definition map and a motion model of the mobile device. In an embodiment, the geographical coordinates of the second road-related element in the high-definition map may be expressed by the longitude and latitude of the earth or UTM coordinates.

In an embodiment, the motion model of the mobile device may be established based on longitudinal and lateral speeds of the mobile device and a yaw rate of the mobile device, offset coordinates of the mobile device relative to the geographical coordinates of the second road-related element in the high-definition map may be calculated based on the motion model, and the mobile device may be positioned based on the offset coordinates and the geographical coordinates of the second road-related element in the high-definition map.

In an exemplary scenario, as shown in FIG. 1B, when the mobile device takes an image, the mobile device is positioned at a solid black point 11 through a GPS mounted on the mobile device, then the solid black point 11 is the first geographical position described in this application, and a real position of the mobile device when taking the image is at position A. Through this application, the first geographical position obtained by GPS positioning can be corrected, and the position of the mobile device when taking the image can be accurately positioned at position A, and the mobile device can be positioned at the current position A′ based on the geographical position of the position A and the motion model of the mobile device.

For example, through the above step 101, the left-turn arrow and the traffic lights included in the image taken by the mobile device at the solid black point 11 are identified, wherein both the left-turn arrow and the traffic lights in the image may be regarded as the first road-related element in accordance with the present disclosure. Respective first feature information of the left-turn arrow and the traffic lights in the image is extracted. Through the above step 102, second feature information of the left-turn arrow in the high-definition map is identified, and second feature information of the traffic lights in the high-definition map is determined, wherein both the left-turn arrow and the traffic lights in the high-definition map may be regarded as the second road-related element in this application. The mobile device is positioned based on a matching result of the first feature information and the second feature information through the step 103 above. For example, if the matching result indicates that the first feature information is identical or similar to the second feature information, the mobile device is positioned at the position A′ based on a geographical position of the left-turn arrow in front of the position A in the high-definition map and the motion model of the mobile device, to obtain the current geographical position of the mobile device at the position A′ in the high-definition map.

In an embodiment, the first feature information is descriptor information of feature points of the first road-related element, such as a Scale-invariant feature transform (SIFT) descriptor or a Speed Up Robust Features (SURF) descriptor, and the second feature information is descriptor information of feature points of the second road-related element, such as a SIFT descriptor or a SURF descriptor. The first feature information includes a plurality of first feature points, descriptors of each first feature point are calculated, and the descriptors of each first feature point are combined together to form a first descriptor subset. The second feature information includes a plurality of second feature points, descriptors of each second feature point are calculated, and the descriptors of each second feature point are combined together to form a second descriptor subset. The descriptors in the first descriptor subset are compared with the descriptors in the second descriptor subset to determine m descriptor pairs, wherein if the descriptor in the first descriptor subset is identical to the descriptor in the second descriptor subset, these two descriptors may be called a descriptor pair. Whether each descriptor pair may be obtained by projective transformation of computer vision is judged. A number n of descriptor pairs that may be obtained by the projective transformation of computer vision is counted. If a ratio of n/m is greater than 0.9, a comparison result of the first feature information and the second feature information meets a preset condition.

It should be noted that the traffic lights and the left-turn arrow shown in FIG. 1B are only an exemplary illustration, and do not form a restriction on this application. As long as the road-related elements are identified from the taken image, the mobile device can be positioned based on the road-related elements identified in the image by the positioning method provided by this application.

In this embodiment, a physical meaning represented by the first road-related element is known by determining the semantic category information of the first road-related element in the image, so the semantic category information of the first road-related element may be regarded as a high-level semantic feature, and the first feature information of the first road-related element and the second feature information of the second road-related element in the high-definition map represent pixel information of the road-related elements, so the first feature information and the second feature information may be regarded as low-level semantic features. By combining the high-level semantic feature with the low-level semantic features, high-accuracy positioning of the mobile device is realized. As the image feature information of the road-related element in the high-definition map is abundant and the image feature information is accurate, and as the whole feature of the road-related element, positioning can be realized through the image feature information without accurately extracting the contour points of the first road-related element in the image, so the extraction accuracy requirement of the contour points on the road-related elements is reduced, and the increase of false positioning failure probability or positioning failure due to inaccurate extraction of contour points or less number of contour points is avoided.

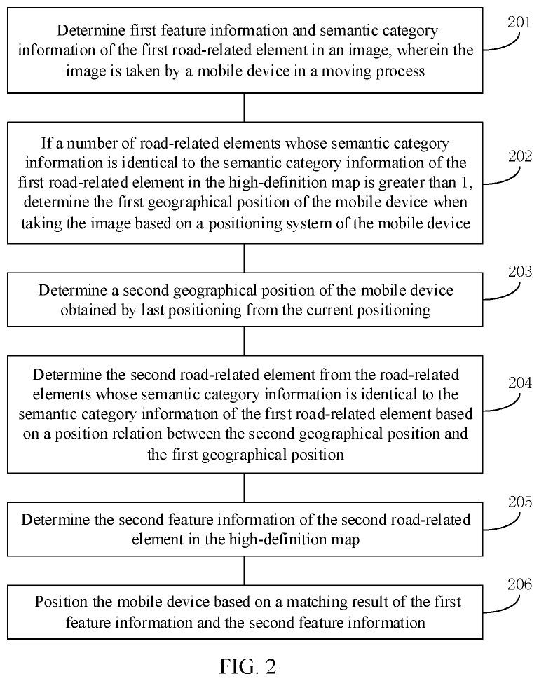

FIG. 2 is a flow chart of a positioning method according to one another exemplary embodiment of this application. On the basis of the above embodiment shown in FIG. 1A and in combination with FIG. 1B, this embodiment takes how to determine second feature information of a second road-related element whose semantic category information is identical to semantic category information of a first road-related element in a high-definition map as an example, as shown in FIG. 2, including the following steps.

In step 201, first feature information and semantic category information of the first road-related element in an image are determined, wherein the image is taken by a mobile device in a moving process.

As shown in FIG. 1B, when a first geographical position of the mobile device when taking the image obtained by GPS positioning is at a solid black point 12, respective first feature information of the first road-related element including traffic lights and straight-ahead arrows is identified from the image, and it is identified that semantic category information of the first road-related element is the traffic signals and the straight-ahead arrows.

In step 202, if a number of road-related elements whose semantic category information is identical to the semantic category information of the first road-related element in the high-definition map is greater than 1, the first geographical position of the mobile device when taking the image is determined based on a positioning system of the mobile device.

As shown in FIG. 1B, if the road-related elements corresponding to the traffic lights and the straight-ahead arrows determined from the high-definition map include straight-ahead arrows and the corresponding traffic lights respectively in front of positions B, C, D and E, a number of the straight-ahead arrows is 4, and a number of the traffic lights is also 4, which are both greater than 1.

In an embodiment, the first geographical position may be determined based on the positioning system on the mobile device. As shown in FIG. 1B, the first geographical position of the mobile device when taking the image is the solid black point 12.

In step 203, a second geographical position of the mobile device obtained by last positioning from the current positioning is determined.

In an embodiment, the second geographical position is the geographical position of the mobile device obtained by last positioning from the current positioning through the embodiment shown in FIG. 1B. As shown in FIG. 1B, the geographical position corresponding to the solid black point 12 is obtained by GPS positioning, and the geographical position obtained by last positioning from the current positioning is the geographical position corresponding to a position F, then the geographical position corresponding to the position F is the second geographical position according to this application.

In step 204, the second road-related element is determined from the road-related elements whose semantic category information is identical to the semantic category information of the first road-related element based on a position relation between the second geographical position and the first geographical position.

As shown in FIG. 1B, based on a position relation between the geographical position at the position F and the position of the solid black point 12, it may be determined that the mobile device goes straight from the position F to an intersection where the solid black point 12 is located, so the mobile device needs to move from the position F to the position B, and thus it can be determined that the corresponding straight-ahead arrow at the position B and the corresponding traffic light are the second road-related element in this application.

In step 205, the second feature information of the second road-related element is determined in the high-definition map.

In an embodiment, a coordinate position of the second road-related element in a vector semantic information layer of the high-definition map, for example, a centroid coordinate of the second road-related element, is determined. The second feature information of the second road-related element is determined based on a coordinate position in an image feature layer of the high-definition map associated with the centroid coordinate. The second feature information of the second road-related element may be determined at a geographical position in the image feature layer of the high-definition map associated with the geographical position in the vector semantic information. As a low-level semantic feature, the second feature information is stored in the image feature layer of the high-definition map.

In step 206, the mobile device is positioned based on a matching result of the first feature information and the second feature information.

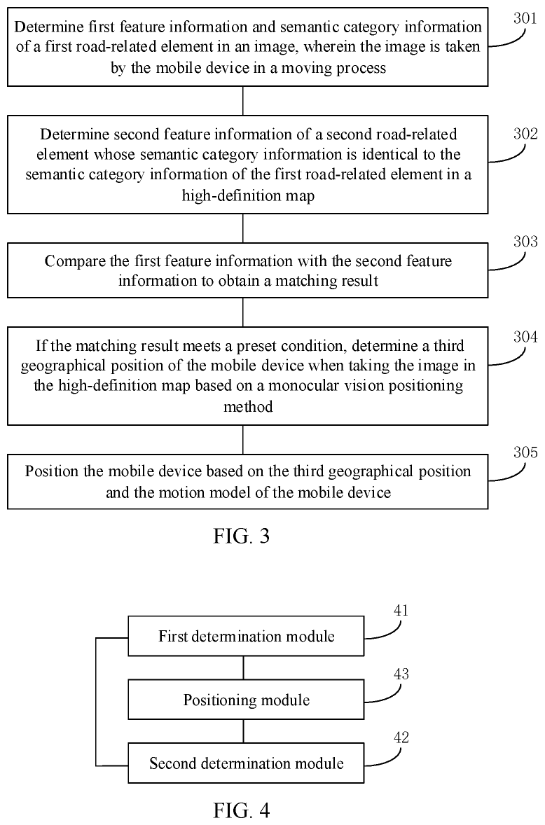

For the description of step 206, reference can be made to the embodiment shown in FIG. 1A above or FIG. 3 below, which will not be elaborated in detail herein.

According to this embodiment, based on the embodiment shown in FIG. 1A, when there are more than two road-related elements whose semantic category information is identical to the semantic category information of the first road-related element in the image, the second road-related element is determined from the road-related element whose semantic category information is identical to the semantic category information of the first road-related element according to the position relation between the second geographical position and the first geographical position of the mobile device obtained by last positioning from the current positioning, which can ensure that a vehicle is positioned at an accurate position and avoid interference of other identified road-related elements on the positioning result.

FIG. 3 is a flow chart of a positioning method according to another exemplary embodiment of this application. On the basis of the above embodiment shown in FIG. 1A, this embodiment takes how to position a mobile device on the basis of a matching result and a motion model of the mobile device as an example, as shown in FIG. 3, including the following steps.

In step 301, first feature information and semantic category information of a first road-related element in an image are determined, wherein the image is taken by the mobile device in a moving process.

In step 302, second feature information of a second road-related element whose semantic category information is identical to the semantic category information of the first road-related element in a high-definition map is determined.

In step 303, the first feature information is compared with the second feature information to obtain a matching result.

For the description of steps 301 to 303, reference can be made to the embodiment shown in FIG. 1A above, which will not be elaborated in detail herein.

In step 304, if the matching result meets a preset condition, a third geographical position of the mobile device when taking the image in the high-definition map is determined based on a monocular vision positioning method.

The preset condition means that a comparison result indicates that the first feature information and the second feature information are identical or similar. In an embodiment, the description of the monocular vision positioning method may refer to the description of the prior art, which will not be elaborated in detail in this application. As shown in FIG. 1B, the third geographical position of the mobile device when taking the image in the high-definition map can be obtained by the monocular visual positioning method, and the third geographical position, for example, is (M, N). In an embodiment, the third geographical position may be represented by longitude and latitude of the earth or UTM coordinates.

In step 305, the mobile device is positioned based on the third geographical position and the motion model of the mobile device.

For the description of the motion model of the mobile device, reference can be made to the embodiment shown in FIG. 1A above, which will not be elaborated in detail herein. For example, if offset coordinates of the mobile device from a time point when taking the image to the current time point are (ΔM, ΔN) through the motion model, the current position of the mobile device is (M+ΔM, N+ΔN).

On the basis of the embodiment shown in FIG. 1A above, this embodiment realizes the positioning of the mobile device based on the third geographical position of the mobile device when taking the image in the high-definition map and the motion model of the mobile device. Because the distance between the first road-related element and the mobile device is relatively short, on the premise that there is a large error in the geographical position of the mobile device when taking the image through the positioning system, error accumulation caused by the positioning system to the positioning result obtained by the mobile device can be avoided by positioning the mobile device through the first road-related element and the motion model of the mobile device, so that the positioning accuracy of the mobile device can be improved.

Corresponding to the foregoing positioning method embodiments, this application further provides positioning device embodiments.

FIG. 4 is a schematic structural diagram of a positioning device according to an exemplary embodiment of this application. As shown in FIG. 4, the positioning device includes:

a first determination module 41, configured to determine first feature information and semantic category information of a first road-related element in an image, wherein the image is taken by a mobile device in a moving process;

a second determination module 42, configured to determine second feature information of a second road-related element whose semantic category information is identical to the semantic category information in a high-definition map; and

a positioning module 43, configured to position the mobile device based on a matching result of the first feature information and the second feature information.

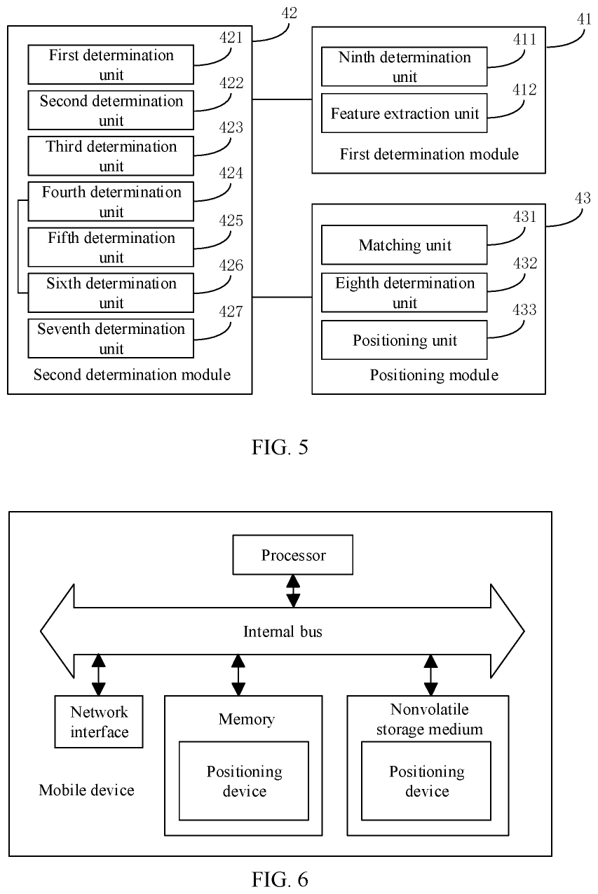

FIG. 5 is a schematic structural diagram of a positioning device according to another exemplary embodiment of this application. As shown in FIG. 5, based on the above-mentioned embodiment as shown in FIG. 4, the second determination module 42 may include:

a first determination unit 421 configured to determine a first geographical position of the mobile device when taking the image based on a positioning system of the mobile device;

a second determination unit 422, configured to determine the second road-related element whose semantic category information is identical to the semantic category information within a set range from the first geographical position in a vector semantic information layer of the high-definition map; and

a third determination unit 423, configured to determine the second feature information of the second road-related element in the high-definition map.

In an embodiment, the second determination module 42 may include:

a fourth determination unit 424, configured to, if a number of road-related elements whose semantic category information is identical to the semantic category information in the high-definition map is greater than 1, determine a first geographical position of the mobile device when taking the image based on a positioning system of the mobile device;

a fifth determination unit 425, configured to determine a second geographical position of the mobile device obtained by last positioning from the current positioning;

a sixth determination unit 426, configured to determine the second road-related element from the road-related elements whose semantic category information is identical to the semantic category information based on a position relation between the second geographical position and the first geographical position; and

a seventh determination unit 427, configured to determine the second feature information of the second road-related element in the high-definition map.

In an embodiment, the seventh determination unit 427 may be specifically configured to:

determine a coordinate position of the second road-related element in a vector semantic information layer of the high-definition map; and

determine the second feature information of the second road-related element based on a coordinate position in an image feature layer of the high-definition map associated with the coordinate position in the vector semantic information layer.

In an embodiment, the positioning module 43 may include:

a matching unit 431, configured to compare the first feature information with the second feature information to obtain the matching result;

an eighth determination unit 432, configured to, if the matching result meets a preset condition, determine a third geographical position of the mobile device when taking the image in the high-definition map based on a monocular vision positioning method; and

a positioning unit 433, configured to position the mobile device based on the third geographical position and a motion model of the mobile device.

In an embodiment, the first determination module 41 may include:

a ninth determination unit 411, configured to determine a position box where the first road-related element is located in the image; and

a feature extraction unit 412, configured to extract the first feature information of the first road-related element from the position box where the first road-related element is located.

In an embodiment, the second feature information corresponding to the second road-related element in the high-definition map is stored in an image feature layer of the high-definition map.

In an embodiment, if the feature information of the road-related element in the high-definition map is stored in the image feature layer of the high-definition map, the semantic category information in the vector semantic information layer is associated with the feature information in the image feature layer.

The positioning device embodiments of this application may be applied to the mobile device. The device embodiments may be implemented by using software, or hardware or in a manner of a combination of software and hardware. Taking the software implementation as an example, as a logical device, it is formed by reading corresponding computer program instructions in a nonvolatile storage medium into a memory by a processor of the mobile device where it is located, so that the positioning method provided in any of the above embodiments of FIG. 1A to FIG. 3 may be executed. In terms of hardware, as shown in FIG. 6, it is a hardware structure diagram of the mobile device where the positioning device according to this application is located. In addition to a processor, a memory, a network interface and a nonvolatile storage medium shown in FIG. 6, the mobile device where the device is located in the embodiment may usually include other hardware according to the actual functions of the mobile device, which will not be elaborated again.

After considering the specification and practicing the present disclosure, a person skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application. The specification and the embodiments are considered as merely exemplary, and the scope and spirit of this application are pointed out in the following claims.

It should be further noted that the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “include a/an . . . ” does not exclude other same elements existing in the process, the method, the article, or the device that includes the element.

1. A positioning method, comprising:
determining first feature information and semantic category information of a first road-related element in an image, wherein the image is taken by a mobile device in a moving process;
determining second feature information of a second road-related element whose semantic category information is identical to the semantic category information in a high-definition map; and
positioning the mobile device based on a matching result of the first feature information and the second feature information.

2. The method according to claim 1, wherein the determining the second feature information of the second road-related element whose semantic category information is identical to the semantic category information in the high-definition map comprises:
determining a first geographical position of the mobile device when taking the image based on a positioning system of the mobile device;
determining the second road-related element whose semantic category information is identical to the semantic category information within a set range from the first geographical position in a vector semantic information layer of the high-definition map; and
determining the second feature information of the second road-related element in the high-definition map.

3. The method according to claim 1, wherein the determining the second feature information of the second road-related element whose semantic category information is identical to the semantic category information in the high-definition map comprises:
if a number of road-related elements whose semantic category information is identical to the semantic category information in the high-definition map is greater than 1, determining a first geographical position of the mobile device when taking the image based on a positioning system of the mobile device;
determining a second geographical position of the mobile device obtained by last positioning from the current positioning;
determining the second road-related element from the road-related elements whose semantic category information is identical to the semantic category information based on a position relation between the second geographical position and the first geographical position; and
determining the second feature information of the second road-related element in the high-definition map.

4. The method according to claim 3, wherein the determining the second feature information of the second road-related element in the high-definition map comprises:
determining a coordinate position of the second road-related element in a vector semantic information layer of the high-definition map; and
determining the second feature information of the second road-related element based on a coordinate position in an image feature layer of the high-definition map associated with the coordinate position in the vector semantic information layer.

5. The method according to claim 1, wherein the positioning the mobile device based on the matching result of the first feature information and the second feature information comprises:
comparing the first feature information with the second feature information to obtain the matching result;
if the matching result meets a preset condition, determining a third geographical position of the mobile device when taking the image in the high-definition map based on a monocular vision positioning method; and
positioning the mobile device based on the third geographical position and a motion model of the mobile device.

6. The method according to claim 1, wherein the determining the first feature information of the first road-related element in the image comprises:
determining a position box where the first road-related element is located in the image; and
extracting the first feature information of the first road-related element from the position box where the first road-related element is located.

7. The method according to claim 1, wherein the second feature information corresponding to the second road-related element in the high-definition map is stored in an image feature layer of the high-definition map.

8-14. (canceled)

15. A storage medium storing a computer program, wherein when the computer program is called, a processor is configured to:
determine first feature information and semantic category information of a first road-related element in an image, wherein the image is taken by a mobile device in a moving process;
determine second feature information of a second road-related element whose semantic category information is identical to the semantic category information in a high-definition map; and
position the mobile device based on a matching result of the first feature information and the second feature information.

16. (canceled)

17. The storage medium according to claim 15, wherein when determining the second feature information of the second road-related element whose semantic category information is identical to the semantic category information in the high-definition map, the processor is configured to:
determine a first geographical position of the mobile device when taking the image based on a positioning system of the mobile device;
determine the second road-related element whose semantic category information is identical to the semantic category information within a set range from the first geographical position in a vector semantic information layer of the high-definition map; and
determine the second feature information of the second road-related element in the high-definition map.

18. The storage medium according to claim 15, wherein when determining the second feature information of the second road-related element whose semantic category information is identical to the semantic category information in the high-definition map, the processor is configured to:
if a number of road-related elements whose semantic category information is identical to the semantic category information in the high-definition map is greater than 1, determine a first geographical position of the mobile device when taking the image based on a positioning system of the mobile device;
determine a second geographical position of the mobile device obtained by last positioning from the current positioning;
determine the second road-related element from the road-related elements whose semantic category information is identical to the semantic category information based on a position relation between the second geographical position and the first geographical position; and
determine the second feature information of the second road-related element in the high-definition map.

19. The storage medium according to claim 18, wherein when determining the second feature information of the second road-related element in the high-definition map, the processor is configured to:
determine a coordinate position of the second road-related element in a vector semantic information layer of the high-definition map; and
determine the second feature information of the second road-related element based on a coordinate position in an image feature layer of the high-definition map associated with the coordinate position in the vector semantic information layer.

20. The storage medium according to claim 15, wherein when positioning the mobile device based on the matching result of the first feature information and the second feature information, the processor is configured to:
compare the first feature information with the second feature information to obtain the matching result;
if the matching result meets a preset condition, determine a third geographical position of the mobile device when taking the image in the high-definition map based on a monocular vision positioning method; and
position the mobile device based on the third geographical position and a motion model of the mobile device.

21. The storage medium according to claim 15, wherein when determining the first feature information of the first road-related element in the image, the processor is configured to:
determine a position box where the first road-related element is located in the image; and
extract the first feature information of the first road-related element from the position box where the first road-related element is located.

22. A mobile device, comprising:
a processor; and
a memory for storing instructions executable by the processor;
wherein the processor is configured to:
determine first feature information and semantic category information of a first road-related element in an image, wherein the image is taken by the mobile device in a moving process;
determine second feature information of a second road-related element whose semantic category information is identical to the semantic category information in a high-definition map; and
position the mobile device based on a matching result of the first feature information and the second feature information.

23. The mobile device according to claim 22, wherein when determining the second feature information of the second road-related element whose semantic category information is identical to the semantic category information in the high-definition map, the processor is configured to:
determine a first geographical position of the mobile device when taking the image based on a positioning system of the mobile device;
determine the second road-related element whose semantic category information is identical to the semantic category information within a set range from the first geographical position in a vector semantic information layer of the high-definition map; and
determine the second feature information of the second road-related element in the high-definition map.

24. The mobile device according to claim 22, wherein when determining the second feature information of the second road-related element whose semantic category information is identical to the semantic category information in the high-definition map, the processor is configured to:
if a number of road-related elements whose semantic category information is identical to the semantic category information in the high-definition map is greater than 1, determine a first geographical position of the mobile device when taking the image based on a positioning system of the mobile device;
determine a second geographical position of the mobile device obtained by last positioning from the current positioning;
determine the second road-related element from the road-related elements whose semantic category information is identical to the semantic category information based on a position relation between the second geographical position and the first geographical position; and
determine the second feature information of the second road-related element in the high-definition map.

25. The mobile device according to claim 24, wherein when determining the second feature information of the second road-related element in the high-definition map, the processor is configured to:
determine a coordinate position of the second road-related element in a vector semantic information layer of the high-definition map; and
determine the second feature information of the second road-related element based on a coordinate position in an image feature layer of the high-definition map associated with the coordinate position in the vector semantic information layer.

26. The mobile device according to claim 22, wherein when positioning the mobile device based on the matching result of the first feature information and the second feature information, the processor is configured to:
compare the first feature information with the second feature information to obtain the matching result;
if the matching result meets a preset condition, determine a third geographical position of the mobile device when taking the image in the high-definition map based on a monocular vision positioning method; and
position the mobile device based on the third geographical position and a motion model of the mobile device.

27. The mobile device according to claim 22, wherein when determining the first feature information of the first road-related element in the image, the processor is configured to:
determine a position box where the first road-related element is located in the image; and
extract the first feature information of the first road-related element from the position box where the first road-related element is located.

28. The mobile device according to claim 22, wherein the second feature information corresponding to the second road-related element in the high-definition map is stored in an image feature layer of the high-definition map.
